(19) United States
(12) Patent Application Publication
(10) Pub. No.: US 2025/0142339 A1
(43) Pub. Date: May 1, 2025

(54) PERFORMING A TRUST EVALUATION SERVICE AT A NETWORK FUNCTION

(71) Applicant: Lenovo (Singapore) Pte. Ltd., New Tech Park (SG)

(72) Inventors: Sheeba Backia Mary Baskaran, Friedrichsdorf (DE); Andreas Kunz, Ladenburg (DE)

(21) Appl. No.: 18/835,279

(22) PCT Filed: Feb. 1, 2023
(86) PCT No.: PCT/IB2023/050894

§ 371 Date: Aug. 1, 2024

Related U.S. Application Data
(60) Provisional application No. 63/306,011, filed on Feb. 2, 2022.

(51) Int. Cl. H04W 12/128

(52) U.S. Cl. CPC H04W 12/128

(57) ABSTRACT

Apparatuses, methods, and systems are disclosed for performing a trust evaluation service at a network function (“NF”). One method includes receiving, at a first NF, a first request message from a second NF. The first request message includes a trust service subscription request message corresponding to a trust service subscription. The method includes performing inference data collection. The method includes performing a trust evaluation service corresponding to the trust service subscription to produce trust evaluation data. The trust evaluation service is performed based at least in part on the inference data collected. The method includes transmitting a first response message to the second NF. The first response message includes information corresponding to the trust evaluation data.

### CROSS-REFERENCE TO RELATED APPLICATIONS

This application claims priority to U.S. Patent Application Ser. No. 63/306,011 entitled “APPARATUSES, METHODS, AND SYSTEMS FOR EVALUATING AND ENSURING TRUST IN A NETWORK” and filed on Feb. 2, 2022 for Sheeba Backia Mary Baskaran et al., which is incorporated herein by reference in its entirety.

### FIELD

The subject matter disclosed herein relates generally to wireless communications and more particularly relates to performing a trust evaluation service at a network function (“NF”).

### BACKGROUND

In certain wireless communications networks, network security attacks may occur. These security attacks may impact operations of user equipments (“UEs”).

### BRIEF SUMMARY

Methods for performing a trust evaluation service at a NF are disclosed. Apparatuses and systems also perform the functions of the methods. One embodiment of a method includes receiving, at a first NF, a first request message from a second NF. The first request message includes a trust service subscription request message corresponding to a trust service subscription. In some embodiments, the method includes performing inference data collection. In certain embodiments, the method includes performing a trust evaluation service corresponding to the trust service subscription to produce trust evaluation data. The trust evaluation service is performed based at least in part on the inference data collected. In various embodiments, the method includes transmitting a first response message to the second NF. The first response message includes information corresponding to the trust evaluation data.

One apparatus for performing a trust evaluation service at a NF includes a processor. In some embodiments, the apparatus includes a memory coupled to the processor, the processor configured to cause the apparatus to: receive a first request message from a second NF, wherein the first request message includes a trust service subscription request message corresponding to a trust service subscription; perform inference data collection; perform a trust evaluation service corresponding to the trust service subscription to produce trust evaluation data, wherein the trust evaluation service is performed based at least in part on the inference data collected; and transmit a first response message to the second NF, wherein the first response message includes information corresponding to the trust evaluation data.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for performing a trust evaluation service at a NF;

FIG. 2 is a schematic block diagram illustrating one embodiment of an apparatus that may be used for performing a trust evaluation service at a NF;

FIG. 3 is a schematic block diagram illustrating one embodiment of an apparatus that may be used for performing a trust evaluation service at a NF;

FIG. 4 is a schematic block diagram illustrating one embodiment of a trust evaluation and security recommendation enabler framework;

FIG. 5 is a schematic block diagram illustrating one embodiment of a trust evaluation and enabler service subscribe and/or unsubscribe process;

FIG. 6 is a schematic block diagram illustrating one embodiment of a direct trust evaluation and notification scenario;

FIG. 7 is a schematic block diagram illustrating one embodiment of an indirect trust evaluation and notification scenario;

FIG. 8 is a schematic block diagram illustrating one embodiment of a trust service related data collection subscribe and/or unsubscribe process; and

FIG. 9 is a flow chart diagram illustrating one embodiment of a method for performing a trust evaluation service at a NF.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

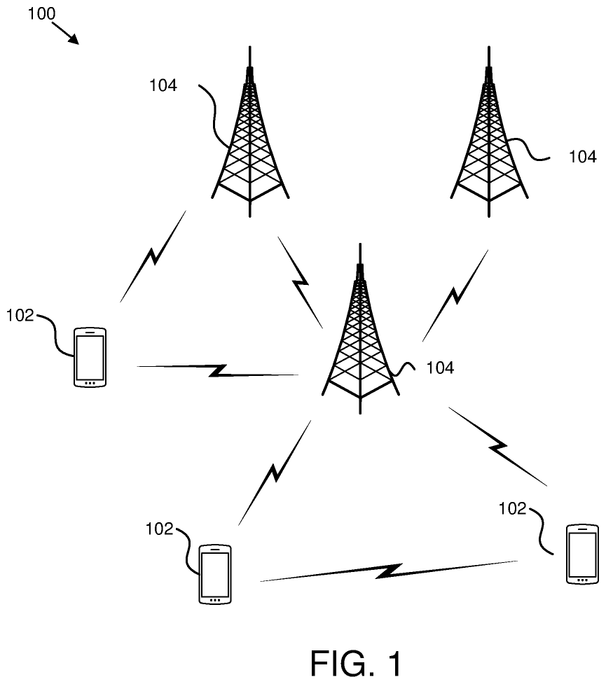

FIG. 1 depicts an embodiment of a wireless communication system 100 for performing a trust evaluation service at a NF. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as

desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via uplink (“UL”) communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a fifth generation (“5G”) node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-third generation partnership project (“3GPP”) gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in 3GPP, wherein the network unit 104 transmits using an orthogonal frequency division multiplexing (“OFDM”) modulation scheme on the downlink (“DL”) and the remote units 102 transmit on the UL using a single-carrier frequency division multiple access (“SC-FDMA”) scheme or an OFDM scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfox, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In certain embodiments, a network unit 104 may receive a first request message from a second NF. The first request message includes a trust service subscription request message corresponding to a trust service subscription. In some embodiments, the network unit 104 may perform inference data collection. In certain embodiments, the network unit 104 may perform a trust evaluation service corresponding to the trust service subscription to produce trust evaluation data. The trust evaluation service is performed based at least in part on the inference data collected. In various embodiments, the network unit 104 may transmit a first response message to the second NF. The first response message includes information corresponding to the trust evaluation data. Accordingly, the network unit 104 may be used for performing a trust evaluation service at a NF.

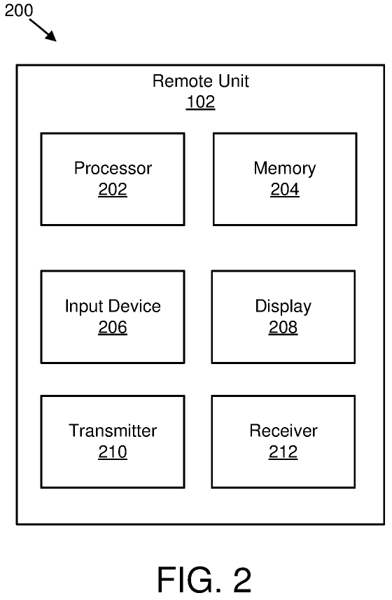

FIG. 2 depicts one embodiment of an apparatus 200 that may be used for performing a trust evaluation service at a NF. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

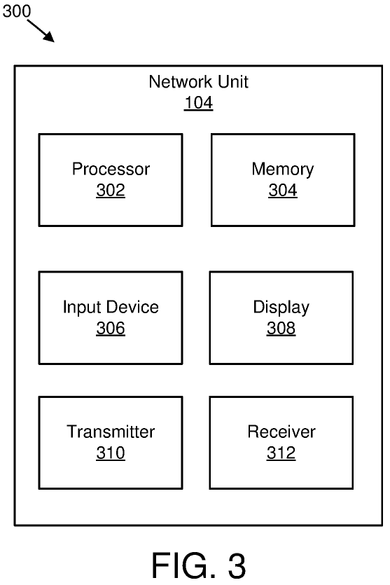

FIG. 3 depicts one embodiment of an apparatus 300 that may be used for performing a trust evaluation service at a NF. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the processor 302 is configured to cause the apparatus to: receive a first request message from a second NF, wherein the first request message includes a trust service subscription request message corresponding to a trust service subscription; perform inference data collection; perform a trust evaluation service corresponding to the trust service subscription to produce trust evaluation data, wherein the trust evaluation service is performed based at least in part on the inference data collected; and transmit a first response message to the second NF, wherein the first response message includes information corresponding to the trust evaluation data.

It should be noted that one or more embodiments described herein may be combined into a single embodiment.

In some embodiments, a 5G system has a static method for enabling trust that enables various NFs involved in the network (e.g., access network and core network) to communicate with each other following a mutual authentication (e.g., based on a transport layer security (“TLS”)) and authorization (e.g., based on OAuth). If any NF is under attack or targeted for a potential compromise and/or hijack, then there may be a potential risk that after mutual authentication and authorization, the NF under threat may impact the UE's service and may impact other communicating NFs by allowing lateral movement of an attack leading to a network service failure.

In various embodiments, zero trust configurations enable a transition from network defense toward a more proactive in-advance security to be in place to combat the security threats if they occur due to malicious operations or compromised network functionalities. In certain configurations, many botnet opportunities exist if there are a large number of connected devices.

In some embodiments, a core principle of zero trust includes continuous trust validation and minimizing impacts if a security breach occurs due to an external factor (e.g., end-users) or by an insider (e.g., compromised or malicious NF). A zero trust approach may prevent a lateral movement threat and may compromise limiting threats and associated risks. A more precise adoption of a zero trust approach for 5G system (“5GS”) security may realize the full potential benefits for vertical service customers, business and ensures service reliability, and the safety of end users.

In certain embodiments, security monitoring supports detection of threats, measuring the security posture of network assets, and compliance with security policies. Monitoring and evaluation of subjects, resources compliance, trustworthiness and state may be important when deciding whether to permit access to resources.

In some embodiments, there may be enhancements to security monitoring and in-advance recommendation for various network operations to enable zero trust security in the 5G system and to facilitate seamless service for end-users while identifying any threats in the network.

A first embodiment corresponds to methods to evaluate and ensure zero trust in a network. This embodiment describes how a network using a trust evaluation and enabler service framework can evaluate a real-time trust of any NFs (e.g., RAN and core network) and end-user devices involved in the 5G system by collecting suitable data and/or information from a target NF under threat (e.g., evaluation target) or from any NF associated with the target NF under threat (e.g., evaluation target). Further the first embodiment also describes how any actions specific to an evaluated critical trust can be recommended to the NFs (e.g., trust service consumers) to prevent any service failure of ongoing critical services and to ensure seamless communication and/or service for the end-users during identification and before termination and/or replacement of compromised NFs.

A network trust evaluation and enabler framework is described in this disclosure. This framework may include one or more trust evaluation and/or enabler service functionalities (e.g., at the RAN and core network side) to compute the trustworthiness of any NF (e.g., RAN or core network) or end-user device associated with the network and to recommend potential network actions (e.g., for trust service consumers) to handle seamless service continuation during any threat identification and/or termination of potentially impacted NFs (e.g., which are under attack).

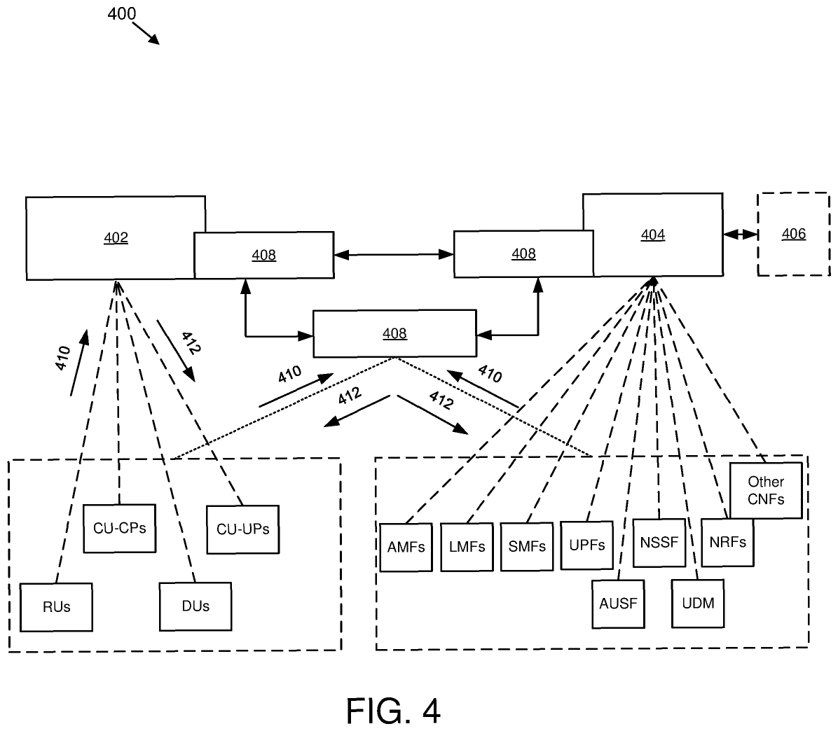

One embodiment of a network trust evaluation and enabler framework is shown in FIG. 4, which may include RAN side analytics functionalities and/or framework module and core network analytics and/or framework module, offering trust evaluation and enabler service either together or as separate functionalities in the framework. There may be a new interface (e.g., a service based interface (“SBI”) or application programming interface (“API”)) between a RAN side analytics functionalities and/or framework module and core network analytics and/or framework module to support data collection and trust evaluation between RAN NFs and core NFs. The trust evaluation service and enabler service function in the core network may interact with another trust evaluation service and enabler service function and/or network data analytics function (“NWDAF”) using the new interface. In some embodiments, a trust evaluation service and enabler service function in a core network may communicate directly with RAN NFs to collect, evaluate, and notify trust service related data. For roaming, a home core network analytics and/or framework module may interface with a serving core network analytics and/or framework module. Both RAN and core network analytics and/or framework module may perform one or more of the following operations using a trust evaluation service and/or trust enabler service functions and/or framework:

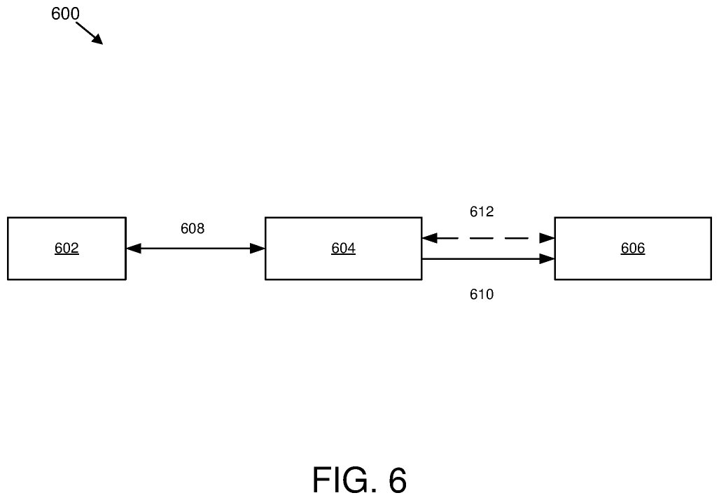

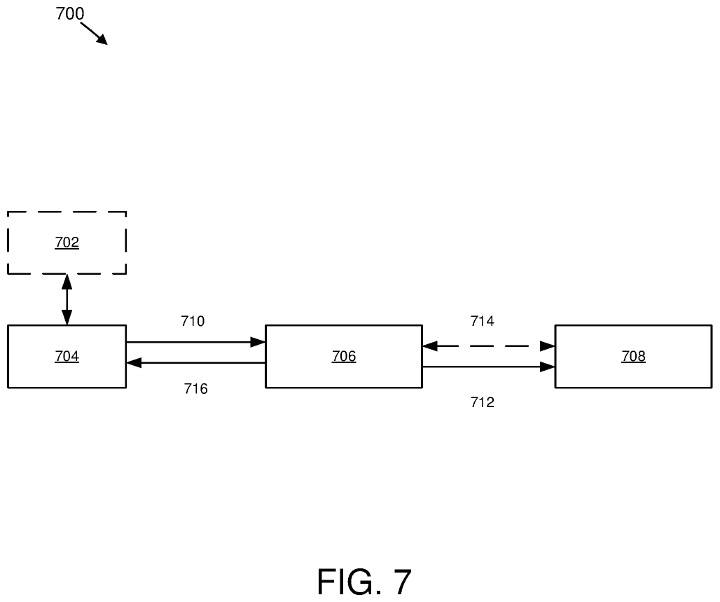

1) data collection of security attributes and/or inference data from a target NF whose trust has to be evaluated. Data collection may be done by a trust evaluation service and/or trust enabler service functions either directly (e.g., as shown in FIG. 6) by requesting the target NF under evaluation or may be done indirectly (e.g., as shown in FIG. 7) by receiving inference data from the service consumers and/or service producers associated with a target NF under evaluation. It should be noted that a NF or a UE which is under evaluation, or which has to be evaluated by the network trust evaluation and enabler framework and/or function may be termed as ‘Evaluation Target’.

2) trust validation and security analysis may be done using the received inference data (e.g., input data related to any security incident or vulnerability findings) and by applying any acquisition indicator (“AI”) and/or machine learning (“ML”) methods to identify the potential attack vectors and/or threat patterns. Trust evaluation service and/or trust enabler service functions and/or framework may have trained models to perform trust validation and security analysis. Any historical data of trust validation and security analysis with appropriate inference data (e.g., input) and relevant threat and/or security issue label (e.g., output) may be used to train a trust validation model. Any AI and/or ML algorithms to be used for the trust evaluation is not in the scope of this disclosure and it can be specific to the operator implementations. It should be noted that trust validation may be implemented using blockchain and trust evaluation related data may be stored on a blockchain with smart contracts.

3) recommendation of actions involve a trust evaluation service and/or trust enabler service functions to provide a more accurate trust value, cause code, and corresponding action code specific to an NF and/or end-user related NF to be executed by any trust service consumer (e.g., any NF service consumer such as network respiratory function (“NRF”), access and mobility management function (“AMF”), session management function (“SMF”), OAM, unified data management (“UDM”), network element function (“NEF”), and so forth). The action code may be related to any network operation to be triggered by the trust service consumer in the network to ensure seamless network service.

FIG. 4 is a schematic block diagram illustrating one embodiment of a trust evaluation and security recommendation enabler framework 400. The trust evaluation and security recommendation enabler framework 400 includes a RAN analytics function and/or framework 402, a core network analytics function and/or framework 404, and other CN analytics function and/or framework 406 which perform trust evaluation and enabler services 408. The RAN analytics function and/or framework 402 communicates interference information 410 and trust information 412 with RUs, distributed units (“DUs”), central unit (“CU”) control planes (“CPs”) (“CU-CPs”), and CU UPs (“CU-UPs”). Moreover, the core network analytics function and/or framework 404 communicates with AMFs, location management functions (“LMFs”), SMFs, user plane (“UP”) functions (“UPFs”), NSSF, AUSF, UDM, NRFs, and other core network functions (“CNFs”).

Evaluating and ensuring trust based on the trust evaluation and security recommendation enabler framework 400 shown in FIG. 4 may involve phase 1, phase 2, phase 3, and/or phase 4 as described herein.

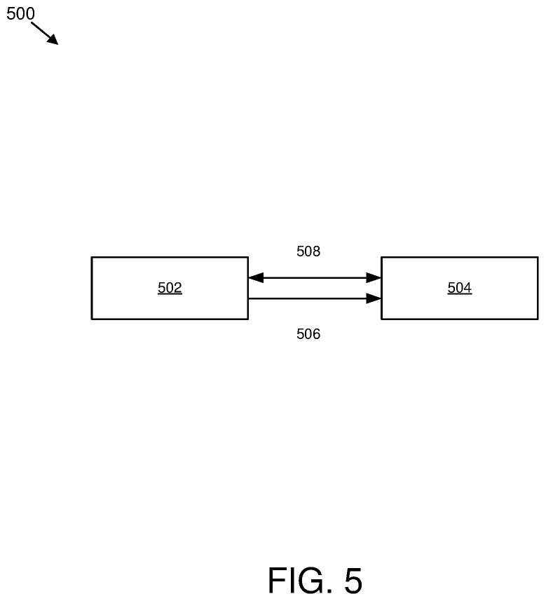

In one embodiment (e.g., phase 1), there is a trust evaluation and enabler service subscribe and/or unsubscribe performed. Any NF may subscribe to the trust evaluation and enabler service function and consumer trust service data as shown in FIG. 5.

FIG. 5 is a schematic block diagram illustrating one embodiment of a trust evaluation and enabler service subscribe and/or unsubscribe process 500. The trust evaluation and enabler service subscribe and/or unsubscribe process 500 includes a trust evaluation and enabler service function 502 that communicates with a trust service consumer NF 504. The trust evaluation and enabler service function 502 transmits a trust data notification and/or recommendation 506 to the trust service consumer NF 504. Moreover, a subscriber request and/or response 508 is communicated between the trust evaluation and enabler service function 502 and the trust service consumer NF 504.

In phase 1, any trust service consumer (e.g., NFs in the RAN, NFs in the core network, including OAM) may subscribe to the trust evaluation service and/or trust enabler service functions (or framework) by invoking trust service subscribe service operation which may include trust service consumer information (e.g., NF Identity (“ID”), NF type, NF fingerprint and/or container fingerprint (e.g., evidences related to an attestation), NF software configuration and/or release information), list of trust service-related service code (e.g., such as configuration issues, attack and/or threat alert, malfunction alert, overload and/or flooding alert, critical location alert, software issues, and so forth), target of trust service reporting (e.g., evaluation of target information): this indicates UE IDs (e.g., or any NF ID with NF type information (e.g., AMF, SMF, user plane function (“UPF”), RAN, RAN, NR node B-central unit-user plane (“gNB-CU-UP”), or any NF, application function (“AF”), and so forth), notification of target address, a subscription correlation identifier, trust service target period and/or reporting mode (e.g., event based and/or periodic), and a trust level specific cause code required indication.

In some embodiments, a trust service consumer may send a terminate and/or cancel request by invoking a trust service unsubscribe service operation. If an AF act as the NF service consumer, then the trust service subscription related request may be exchanged via a NEF. In various embodiments, a trust evaluation service may also subscribe to related analytics information from the NWDAF.

In certain embodiments, for consumer subscribers to a trust evaluation service and/or trust enabler service functions (e.g., or framework), then the consumer subscribers may be provided with a trust service subscribe notify service operation by including a success indication and validity period for the subscription.

In some embodiments, the trust evaluation service and/or trust enabler service functions (e.g., or framework) may at anytime cancel a subscription for the trust service consumer based on a local policy or if a cancel and/or terminate request is received from the service consumer.

In various embodiments (e.g., phase 2), a trust evaluation and enabler service request may be used. A trust service consumer (e.g., any NFs, AF, and/or OAM) may request and get trust service data, such as trust evaluation and security analysis information, about any of it's own NF service consumers, service producers, and/or about itself from the trust evaluation, enabler service function, or framework using a trust evaluation service get request operation.

In certain embodiments, based on an operator policy or based on any trust service consumer subscription and/or request, the trust evaluation and/or enabler service function or framework may at anytime trigger a trust related data request from the target NF to be evaluated.

FIG. 6 is a schematic block diagram illustrating one embodiment of a direct trust evaluation and notification scenario 600. The direct trust evaluation and notification scenario 600 includes an NF-A under evaluation module 602, a trust evaluation and enabler service function 604, and a trust service consumer NF 606. It should be noted that, as used herein, a trust evaluation may mean security monitoring and/or security evaluation. Trust related data 608 about NF-A collection from NF-A is communicated between the NF-A under evaluation module 602 and the trust evaluation and enabler service function 604. Moreover, the trust evaluation and enabler service function 604 transmits a trust data notification and/or recommendation 610 to the trust service consumer NF 606. Moreover, a subscriber request and/or response 612 is communicated between the trust evaluation and enabler service function 604 and the trust service consumer NF 606.

FIG. 7 is a schematic block diagram illustrating one embodiment of an indirect trust evaluation and notification scenario 700. The indirect trust evaluation and notification scenario 700 includes an NF-A under evaluation module 702, a trust service consumer-NF-B 704, a trust evaluation and enabler service function 704, and a trust service consumer NF C 706. Trust related data 710 about NF-A collection from NF-B is communicated between the trust service consumer-NF-B and the trust evaluation and enabler service function 706. Moreover, the trust evaluation and enabler service function 706 transmits a trust data notification and/or recommendation 712 to the trust service consumer NF 708. Moreover, a subscriber request and/or response 714 is communicated between the trust evaluation and enabler service function 706 and the trust service consumer NF 708. Further, the trust evaluation and enabler service function 706 transmits a trust data notification and/or recommendation 716 to the trust evaluation and enabler service function 704.

In some embodiments, a trust service consumer may request trust evaluation information from the trust evaluation and/or enabler service function or framework by invoking a trust evaluation service get request (e.g., Ntrustservice_evaluation_get Request) service operation, which may include a trust service consumer information (e.g., NF ID, NF type, NF fingerprint and/or container fingerprint or blueprint (e.g., it can be evidences related to an attestation), NF software configuration and/or release information), target trust evaluation NF identification (e.g., NF ID, NF type of the NF which need to be evaluated-can be called as target evaluation information), and target inference data either identified locally or received from another NF (e.g., errors, any malformed packet and/or suspicious message received). In various embodiments, other input parameters may be included similar to a subscription request.

In certain embodiments, when a request for a trust evaluation service is received, the trust evaluation and/or enabler service function or framework determines whether triggering new data collection (e.g., phase 4) is needed.

In some embodiments, inference data can be any information available at a trust service consumer (e.g., fetched locally or received from any NF service consumer and/or producer associated and/or interfacing with the trust service consumer), which may be used to evaluate the trust of a target NF and/or UE by the trust evaluation platform (e.g., it can be equivalent to a security monitoring function). Where the inference data is fetched locally from the trust service consumer, the target NF under evaluation may be the same as the trust service consumer. In various embodiments, if inference data is received from any other NF service consumer and/or procedure of a trust service consumer, then the target NF under evaluation will be the respective NF service consumer and/or procedure of the trust service consumer.

In certain embodiments, some inference data which can used by the trust evaluation and enabler service (e.g., when provided by the trust service consumer) as input to the trust evaluation service platform to perform security analysis and trust evaluation can include information corresponding to one or more of the following: 1) messages violating a predefined service operation input and/or output format or type (e.g., a malformed message); 2) an NF and/or container image or blueprint (e.g., signed or actual data); 3) an NF deployed location and platform information; 4) a software configuration information change; 5) any malicious trigger and/or alert related from other NFs intruding activity (e.g., in any port or if any closed port is opened and/or enabled with a malicious method); 6) any trigger and/or alert related to an unintended configuration and/or operational change; 7) an observation of service, message load, and/or request exceeding a configured limit per time instance, period, and/or slice; 8) a repeated authentication failure for a subscription concealed identifier (“SUCI”) and/or subscription permanent identifier (“SUPI”), or any SUPI and security information management (“SIM”) credentials mismatch; 9) a network generated and/or UE generated location mismatch related to any location services (“LCS”) client request for any SUPI, UE ID, and/or group of UEs; 10) radio resource control (“RRC”) overflow and/or flooding related to any UE ID; 11) non-access stratum (“NAS”) overflow and/or flooding related to any UE ID; 12) malicious subscription data request flooding and/or overflow for any UE IDs at a UDM (e.g., by an AMF); 13) malicious traffic and/or message flooding from a UE to local UPFs; and/or 14) malicious signaling and/or message flooding from a RAN to local UPFs.

In some embodiments, a trust evaluation and/or enabler service function or framework responds to a trust service consumer with trust evaluation information by invoking a trust evaluation service response message (e.g., Ntrustservice_evaluation Response). The trust evaluation service response may include a trust value (e.g., corresponding to inference data received in a request), a cause code related to the inference data (e.g., indicating: configuration issues, an attack and/or threat alert, a malfunction alert, an overload and/or flooding alert, a critical location alert, software issues, incorrect location information, security and/or trust zone restrictions), recommended actions, and/or a timestamp and/or time reference for the evaluation (e.g., or a time window, which may be used by a trust consumer to rely upon the data for a length of time up to the time window).

In various embodiments, there may be a trust value (e.g., a reference value such as a value of: 0 to 20 indicating low and/or fully compromised (e.g., non-compliant), 21 to 50 indicating medium and/or partially compromised (e.g., compliant), 50 to 99 indicating high, minor threats, and/or issues in compliance, and 100 indicating fully trusted (e.g., secure and compliant)) that may indicate the serving capability and/or expectation of a target NF with reference to a severity level of security impact in the target NF's (e.g., related to the inference data and the root cause associated with the inference data). The trust value may be a trust level index per NF (e.g., trust levels may be configured based on an operator policy).

In certain embodiments, a cause code may indicate a value specific to issues or threats identified by a trust evaluation and enabler service platform, where the cause code may indicate any one or more of the following: 1) a denial of service (“DoS”); 2) a distributed denial of service (“DDOS”); 3) an injection attack (e.g., malicious code injected); 4) that an NF is hijacked and/or compromised; 5) NF configuration and/or software issues; 6) flooding on a specific 5G system interface; 7) a man-in-the-middle attack; 8) a protocol or implementation flaw (e.g., attackers may control the network); 9) NFs that are deployed and/or managed in a less trusted zone (e.g., gNB-CU-UPs deployed in untrusted security zone or less trusted platform and/or an AMF belongs to a less trusted platform, service provider, and/or local UPF deployed in a less trusted location); and/or 10) a flooding attack on a security edge protection proxy (“SEPP”).

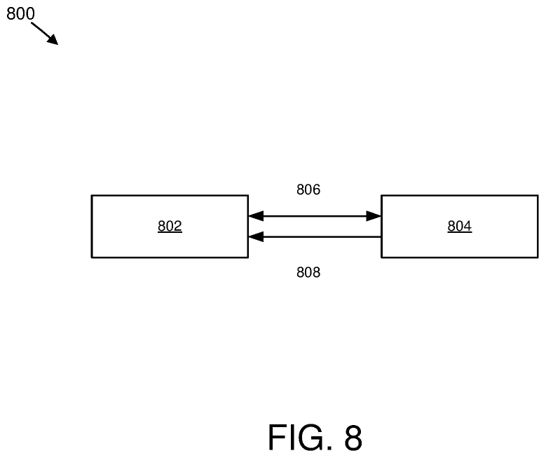

In some embodiments, a trust evaluation and enabler service framework may subscribe to trust data producers (e.g., any NFs for collecting inference data related to the any threat incidents) for data notification related to inference data as shown in FIG. 8, and there may be a suitable trust event name assigned to it.

In various embodiments, recommendations of actions may include one or more of the following related to any specific inference data and corresponding trust evaluation: 1) NF and/or network slice selection enforcement based on a trust value; 2) network slice selection assistance information (“NSSAI”) and/or single NSSAI (“S-NSSAI”) configuration with a required trust value in target NFs (e.g., a trust service consumer may include a UDM, network slice selection function (“NSSF”), and/or AMF); 3) security context sharing and/or usage policy enforcement (e.g., to a policy control function (“PCF”) and/or UDM to be enforced at a NAS level, access-stratum (“AS”) level, RRC level, UP level, or a combination of these); 4) a trigger for network slice-reselection; 5) that an NSSF can maintain a trust value per network slice with a time record; 6) UE context sharing restrictions for NFs (e.g., a trust service consumer may include restrictions for a UDM, an authentication server function (“AUSF”), and/or an AMF); 7) an SBI connection release, termination, and/or conditional re-establishment after a security patch is executed successful (e.g., for any flooding attack and/or sniffing); 8) a trigger of UE de-registration with a re-registration indication for a new and/or equivalent slice; 9) an indication to trigger RRC connection release and assign a back-off timer; 10) an indication to terminate a malicious relay node and/or reselect a relay node; 11) network triggered N2 handover and/or AMF reallocation (e.g., if the initial AMF has a smaller trust value); and/or 12) a network triggered X2 handover and/or RAN reallocation (e.g., if the initial RAN function has a less trust value).

In certain embodiments (e.g., phase 3), there may be trust data collection from NFs (e.g., this may be a sub-phase of phase 2). When a request or subscription for a trust service is received, the trust evaluation service function and/or framework may not have all necessary information to perform the service. For example, the trust evaluation service function and/or framework may not have a current state of a target NF whose trust needs to be evaluated. The current state of the NF may include overall an NF's configuration information, software information, access privilege information, an NF's container state and/or platform state, any open ports available, a current NF's integrity (e.g., with respect to NF package integrity as recorded during an initial NF step up), and so forth.

In some embodiments, a trust evaluation service function and/or framework may collect trust service-related data (e.g., related to a target NF under evaluation) from various NFs such as an NRF, an OAM, an AMF, an SMF, RAN NFs, an NSSF, a UDM, an NEF, an AF, and/or from the target NF under evaluation itself (e.g., as shown in FIG. 8).

FIG. 8 is a schematic block diagram illustrating one embodiment of a trust service related data collection subscribe and/or unsubscribe process 800. The trust service related data collection subscribe and/or unsubscribe process 800 includes a trust evaluation and enabler service function 802 that communicates with a trust service data producer NF 804. An inference data subscribe request and/or response 806 is communicated between the trust evaluation and enabler service function 802 and the trust service data producer NF 804. The trust service data producer NF 804 transmits an inference data notification 806 to the trust evaluation and enabler service function 802.

In various embodiments, a trust evaluation service function and/or framework can subscribe to RAN and core NFs for event exposure service by providing a trust evaluation service function, a framework identity, an address, security credentials (e.g., as configured by an operator), and/or a trust event identity.

In certain embodiments, a the trust event identity may be related to any of the following: 1) messages violating a predefined service operation input, output format, and/or type (e.g., malformed message from any NFs); 2) an NF and/or container image (e.g., signed) from any NF or from NRF for other NFs; 3) an NF deployed location and platform information (e.g., from any NFs); 4) a software configuration information change (e.g., from any NFs); 5) any malicious trigger and/or alert or information corresponding to other NFs intruding activity (e.g., in any port or if any closed port is opened and/or enabled with a malicious method, such as from any NF); 6) any trigger and/or alert related to an unintended configuration and/or operational change (e.g., from any NF); 7) observation of service, message load, and/or requests exceeding a configured limit per time instance, period, and/or slice (e.g., from any NF); 8) repeated authentication failure for some SUCI and/or SUPI or any SUPI and SIM credentials mismatch (e.g., from a UDM); 9) a network generated and UE generated location mismatch related to any LCS client request for any SUPIs/UE Ids/group of UEs (from AMF or any location information handling function such as LCS); 10) RRC overflow and/or flooding related to any UE ID (e.g., from RAN NFs); 11) NAS overflow and/or flooding related to any UE ID (e.g., from an AMF); 12) malicious subscription data request flooding and/or overflow for any UE ID at the UDM (e.g., by the AMF, from a UDM); 13) malicious traffic from the UE to local UPFs (e.g., from RAN or UPF); and/or 14) malicious signaling from a RAN to local UPFs (e.g., from a UPF).

In some embodiments, NFs can transmit data to a trust evaluation service function and/or framework if any trust even related incidents occur at the NF. In various embodiments, NFs can provide a notification about trust related event data when specifically requested.

In certain embodiments, every NF (e.g., in the RAN and core network), while instantiated by the network operator, can also be configured with a related NF image and/or package digest (e.g., NF image and/or package sign) computed using a private key configured for the NF. A public key to check the related NF digest may be configured in an NRF and/or OAM and a trust evaluation service function and/or framework along with a corresponding NF Identity. The NF package sign verification may help any verifier (e.g., trust evaluation service) to verify the integrity of the NF package.

In some embodiments, during a trust evaluation service a trust evaluation and enabler service function and/or framework may request an NF package sign from a target NF which is under evaluation by sending a challenge (e.g., freshness parameter such as nonce, random number, counter, and so forth). In various embodiments, a trust evaluation and enabler service function and/or framework may request NF package information (e.g., software configuration information, image, and/or blueprint) from a target NF that is under evaluation.

In certain embodiments, an NF under trust evaluation may compute a fresh NF package digest using a current NF package and using a challenge provided by a trust evaluation and enabler service function and/or framework. The NF may notify the trust evaluation and enabler service function and/or framework about all trust-based event information requested along with an

NF package sign.

In some embodiments, an initial NF package digest and/or sign may include: a hash (e.g., NF package information, initial state code) that is available in a target NF that is under evaluation, a trust evaluation service framework, a NRF, and/or an OAM.

In various embodiments, a subsequent NF package digest and/or sign may include: a hash (e.g., current NF package information, a challenge) that is generated by a target NF that is under evaluation, and/or a trust evaluation service framework (e.g., further verified by a trust evaluation service framework). If the trust evaluation service framework requires any information for verifying an NF package digest, related information (e.g., public key of a target NF under evaluation) may be fetched from an NRF and/or an OAM.

In certain embodiments, an NF under trust evaluation (e.g., evaluation target) may provide a current state of NF package information (e.g., software configuration information, image, or blueprint) to a trust evaluation and enabler service function and/or framework. In some embodiments, a trust evaluation service function and/or framework may verify the integrity of an NF package sign and use additional trust event identity related information to perform trust evaluation and security analysis to determine any potential threat associated with an NF under evaluation.

In various embodiments, a trust evaluation and enabler service function and/or framework may verify if received NF package information (e.g., software configuration information, image, and/or blueprint) from a target NF that is under evaluation matches with available (e.g., available locally, from an NRF, and/or from a blockchain) NF package information (i.e., software configuration information or image or blueprint).

In certain embodiments (e.g., phase 4), trust NF service consumers may execute recommended actions received from a trust evaluation service function and/or framework.

In some embodiments, for each recommended action provided by a trust evaluation and enabler service function and/or framework (“TESF”), a trust service consumer can trigger a network operation such as one or more of the following:

1) NF and/or network slice selection enforcement based on a trust value: the TESF can send a notification to a trust service consumer (e.g., NSSF, UDM, NRF, and/or any NF) for any related trust service event notification along with an impacted target NF identification information, trust value, and recommended action as, ‘NF/network slice selection enforcement based on Trust value’. The trust service consumer configures network slice selection information available at an AMF, a UDM, an NSSF, and/or an NRF to down prioritize the ‘Impacted Target NF’ to remove and isolate from all slice selection information and slice availability information, to prevent any further selection, and use of the impacted NF for any service. In addition, the trust service consumer triggers slice re-selection (e.g., if the impacted NF is RAN, then RAN slice need to be reselected and/or relocated; if the impacted NF is AMF, then AMF slice need to be reselected and/or relocated; if the impacted NF is an SMF and/or an UPF, then the SMF and/or the UPF slice need to be reselected and/or relocated) for all the UEs that are being served by the ‘Impacted Target NF’ to enable service continuity for the UEs even if the network management services or trust services terminates the impact NF at some point that may not impact any UE and/or network service. Trust level-based NF and/or slice selection for the UE service needs to be adopted (e.g., NF or network slice with a trust level below some threshold should not be selected for critical services (such as vehicle-to-everything (“V2X”) and/or unmanned aerial system (“UAS”))), where a trust level index (or values) may be configured with S-NSSAI and/or data network name (“DNN”) restriction information in the NFs which performs network slice selection and the NF selects only NFs and/or network slices which have the trust value similar or higher than the configured trust values for a related the S-NSSAI and/or DNN (e.g., by verifying and/or checking the network slice (or NF) related trust value with trust value restrictions of the S-NSSAI and/or DNN).

2) an NSSAI and/or S-NSSAI configuration with a required trust value in target NFs (e.g., trust service consumer may include a UDM, NSSF, and/or AMF): the TESF can send a notification to the trust service consumer (e.g., NSSF, UDM, AMF, NRF, and/or any NF) for any related trust service event notification along with impacted target NF identification information, a trust value, and a recommended action as, ‘NSSAI/S-NSSAI configuration with required Trust value in target NFs’. Where the trust service consumer triggers configuration of slice selection information by adding slice selection restrictions for various one or more target NFs based on an evaluated trust value (e.g., if it has a very low trust value) to serve only limited NSSAIs and/or S-NSSAIs which are related to general services (e.g., broadcast or media services) and which does not offer any critical services such as UAS and/or V2X.

3) security context sharing and/or usage policies enforcement (e.g., sent to PCF and/or UDM to be enforced at an NAS level, AS level, RRC level, UP level, or a combination of these): the TESF may send a notification to the trust service consumer (e.g., NSSF, UDM, AMF, PCF, SMF, RAN, and/or any NF) for any related trust service event notification, along with impacted target NF identification information, a trust value, and a recommended action as ‘Security context sharing/usage policies enforcement (to enforce cryptographic separation at NAS level/AS level/RRC level/UP level or a combination of these) required’. Where the trust service consumer triggers configuration and enforcement of slice security isolation against the evaluated NF (e.g., which has a lower trust value) or an update configuration of a network slice simultaneous registration group to exclude the evaluated NF (e.g., which has a lower trust value) to prevent any potential cross-slice attack and/or security issues. Further, the trust service consumer can also trigger to restrict any potential security context sharing among the evaluated NF (e.g., which has a lower trust value) and other slices. If a target NF (e.g., AMF) receives a service request (e.g., handover and/or direct reallocation) from another NF (e.g., initial AMF) with a lower trust level, then the target NF may only use a new security context to establish any connection with the UE (e.g., reuse of Kamf should not be done).

4) trigger for network slice-reselection: the TESF can send a notification to the trust service consumer (e.g., NSSF, UDM, NRF, any NF) for any related trust service event notification, along with impacted target NF identification information, a trust value, and a recommended action as, ‘Trigger for network slice-reselection’ required. The trust service consumer triggers slice re-selection (e.g., if the impacted NF is RAN, then a RAN slice need to be reselected and/or relocated;

if the impacted NF is an AMF, then the AMF slice need to be reselected and/or relocated; if the impacted NF is SMF and/or UPF, then the SMF and/or UPF slice need to be reselected and/or relocated) for all the UEs that are being served by the ‘Impacted Target NF’ to enable service continuity for the UEs even if the network management services or trust services terminates the impact NF at some point, that may not impact any UE and/or network service.

5) the NSSF and/or NRF can maintain a trust value per network slice with a time record: the TESF can send a notification to the trust service consumer (e.g., NSSF, NRF, and/or any NF) for any related trust service event notification, along with impacted target NF identification information, a trust value, and a recommended action as, ‘NF Trust value per network slice update notification with time record’. Where the trust service consumer updates the trust values of all NFs in the local configuration as provided by the TESF for further trust-based network slice usage and security enforcement.

6) UE context sharing restrictions NFs (e.g., trust service consumer may include a UDM, a AUSF, and/or an AMF): the trust service consumer behavior may be the same as for recommended action 3 above. There may be security context sharing and/or usage policies enforcement. The trust service consumer can trigger to restrict any potential security context sharing among the evaluated NF (e.g., which has a lower trust value) and other slices.

7) SBI connection release, termination, and/or conditional re-establishment after a security patch is executed successful (e.g., for any flooding attack and/or sniffing): the TESF can send a notification to the trust service consumer (e.g., NSSF, NRF, and/or any NF) for any related trust service event notification, along with impacted target NF identification information, a trust value, and a recommended action as, ‘SBI connection release/termination/conditional re-establishment after security patch is executed successful (i.e., for any flooding attack/sniffing)’. The trust service consumer may designate an equivalent NF to take over the service offered by the evaluated NF which has a lower trust value; and release any SBI interface connection with an evaluated NF which has a lower trust value. Where required, if the UE service is done with the evaluated NF which has a lower trust value, then the equivalent NF is made to continue the service operations for the UE to ensure service continue, despite termination, and SBI connection release with the low trust NF.

8) trigger UE de-registration with a re-registration indication transmitted to a new and/or equivalent slice: the TESF can send a notification to the trust service consumer (e.g., UDM, AMF, any NF, UE, and/or NSSF) for any related trust service event notification, along with impacted target NF identification information, a target UE identification (e.g., one or more UE IDs or groups IDs), a trust value, and a recommended action as, ‘Trigger UE de-registration with a re-registration indication to a new/equivalent slice’. The trust service consumer triggers re-registration for all the UEs that are being served by the ‘Impacted Target NF’ to enable service continuity for the UEs even if the network management services or trust services terminates the impact NF at some point that may not impact any UE and/or network service.

9) trigger an RRC connection release and assign a back-off timer: the TESF may send a notification to the trust service consumer (e.g., RAN and/or any NF) for any related trust service event notification, along with impacted target NF identification information, a target UE identification (e.g., one or more UE IDs or groups IDs), malicious UE information, a trust value, and a recommended action as, ‘Trigger RRC connection release and assign back-off timer’. If any UE, group of UEs, and/or relay nodes are identified to perform DoS, DDOS, and/or flooding attacks over the RAN, then the trust service consumer triggers the RRC connection release for all the target malicious UEs identified by the trust evaluation service.

9a) trigger network connection release and assign back-off timer: the TESF may send a notification to the trust service consumer (e.g., AMF, UDM, and/or any NF) for any related trust service event notification, along with impacted target NF identification information, target UE identification (e.g., one or more UE IDs or groups IDs), malicious UE information, a trust value, and a recommended action as, ‘Trigger connection release and assign back-off timer’. If any UE and/or group of UEs are identified to perform DoS, DDOS, and/or flooding attacks over the core network, then the trust service consumer triggers de-registration and connection release for all the target malicious UEs identified by the trust evaluation service.

10) terminate a malicious relay node and/or reselect relay node: the TESF may send a notification to the trust service consumer (e.g., RAN, UE, UDM, and/or any NF) for any related trust service event notification, along with impacted target NF identification information, target UE identification (e.g., one or more UE IDs or groups IDs), malicious UE relay node information, a trust value, and a recommended action as, ‘Terminate malicious relay node and/or reselect relay node’. If relay nodes are identified to perform DoS, DDOS, flooding attacks, and/or sniffing over the RAN, then the trust service consumer triggers RRC connection release for all the target malicious relay UEs identified by the trust evaluation service. Meanwhile, the trust service consumer also notifies the UE to reselect the UE relay node for service continuity over any NAS message and/or RRC and further the trust service consumer forbids the relay node from further relay services based on an operator's policy.

11) network triggered N2 handover and/or AMF reallocation (e.g., if the initial AMF has a less trust value): the TESF may send a notification to the trust service consumer (e.g., AMF, NSSF, NRF, UDM, NRF, and/or any NF) for any related trust service event notification, along with impacted target NF identification information, a trust value, and a recommended action as, ‘Network triggered N2 handover/AMF Reallocation’ required. The trust service consumer may trigger N2 handover and/or AMF reallocation with or without a security context transfer between the impacted NF and the new AMF based on an operator's local policy.

12) network triggered X2 handover and/or RAN reallocation (e.g., if the initial RAN function has a less trust value): the TESF can send a notification to the trust service consumer (e.g., AMF, NSSF, NRF, UDM, NRF, and/or any NF) for any related trust service event notification, along with impacted target NF identification information, a trust value, and a recommended action as, ‘Network triggered X2 handover/RAN Reallocation’ required. The trust service consumer may trigger X2 handover and/or RAN reallocation with or without a security context transfer between the impacted NF and the new RAN NF (e.g., gNB) based on an operator's local policy. It should be noted that the functionalities defined for the trust evaluation service may be offered using NWDAF, messaging framework, or using a data collection coordination function (“DCCF”).

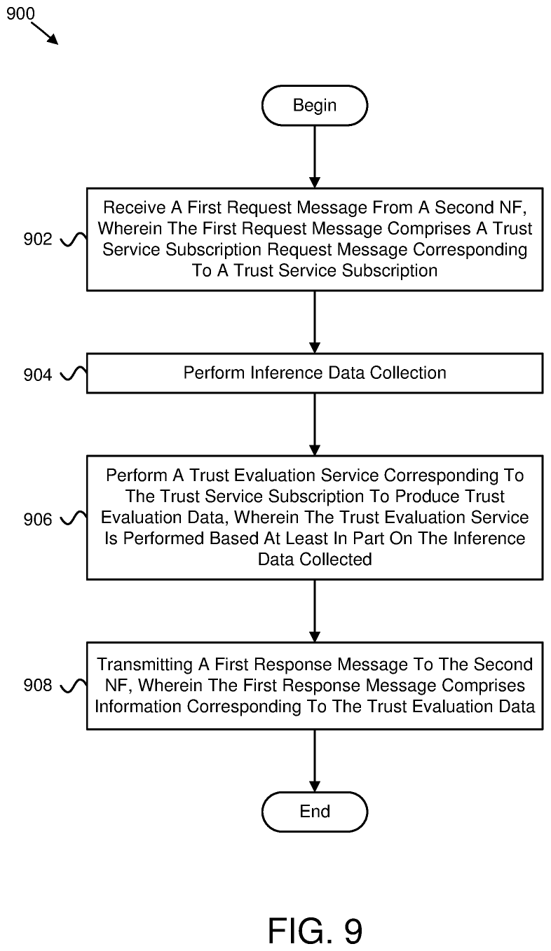

FIG. 9 is a flow chart diagram illustrating one embodiment of a method 900 for performing a trust evaluation service at a NF. In some embodiments, the method 900 is performed by an apparatus, such as the network unit 104. In certain embodiments, the method 900 may be performed by a processor executing program code, for example, a microcontroller, a microprocessor, a CPU, a GPU, an auxiliary processing unit, a FPGA, or the like.

In various embodiments, the method 900 includes receiving 902, at a first NF, a first request message from a second NF. The first request message includes a trust service subscription request message corresponding to a trust service subscription. In some embodiments, the method 900 includes performing 904 inference data collection. In certain embodiments, the method 900 includes performing 906 a trust evaluation service corresponding to the trust service subscription to produce trust evaluation data. The trust evaluation service is performed based at least in part on the inference data collected. In various embodiments, the method 900 includes transmitting 908 a first response message to the second NF. The first response message includes information corresponding to the trust evaluation data.

In certain embodiments, the first NF comprises a TESF, security monitoring and evaluation function, network data analytics function, or a combination thereof. In some embodiments, the second NF comprises a trust service consumer function. In various embodiments, the first request message further comprises trust service consumer information, evaluation target information, or a combination thereof.

In one embodiment, the trust service consumer information comprises a NF ID, an NF type, an NF fingerprint, a container fingerprint, an NF software configuration, release information, or a combination thereof. In certain embodiments, the first request message further comprises a list of trust service related service codes, configuration issue information, an attack alert, a threat alert, a malfunction alert, an overload alert, a flooding alert, a critical location alert, software issue information, a target of trust service reporting, evaluation target information, a notification of a target address, a subscription correlation identifier, a trust service target period, a reporting mode, a trust level specific cause code required indication, or a combination thereof. In some embodiments, the evaluation target information comprises a UE ID, a NF ID having NF type information, an AF ID having AF information, or a combination thereof.

In various embodiments, the inference data comprises: data from evaluation targets, a malformed message, a signed NF information, a container image, a package, NF deployed location and platform information, a software configuration information change alert, a malicious activity alert, malicious behavior information, a trigger and/or alert related to an unintended configuration and/or an operational change, a message exceeding a configured limit per time instance, repeated authentication failure information, a network generated location mismatch, a UE generated location mismatch, RRC overflow information related to any UE ID, NAS overflow information related to any UE ID, malicious subscription data request overflow for any UE ID at a UDM, malicious traffic information for local UPFs from the UE, malicious signaling to the local UPFs from a RAN, or a combination thereof. In one embodiment, the interference data is collected from evaluation targets using another NF or a management function. In certain embodiments, the method 900 further comprises receiving a second request message from the second NF, wherein the second request message comprises a trust evaluation request message corresponding to the trust service subscription.

In some embodiments, the method 900 further comprises receiving a third request message from the second NF, wherein the third request message comprises a trust service unsubscription request message corresponding to the trust service subscription. In various embodiments, the first response message further comprises trust information, a root cause code, a recommended action to ensure seamless network service, or a combination thereof. In one embodiment, the trust information comprises values to represent a security state of an evaluation target NF, values to represent a reliability of the evaluation target NF, values to represent a trust worthiness of the evaluation target NF, or a combination thereof.

In certain embodiments, the root cause code comprises a code corresponding to: man-in-the middle attack, DOS attack, DDOS attack, an injection attack, a flooding attack on a SBI, a flooding attack on a SEPP, a NF hijack, a NF compromise, IP spoofing, a protocol or implementation flaw, an NF deployment location, a security threat, or a combination thereof. In some embodiments, the recommended action comprises information indicating: network slice selection enforcement based on a trust value, a NSSAI configuration with a required trust value, security context sharing and/or usage policy enforcement information, a trigger for network slice reselection, an update to maintain a trust value per network slice within a time window, UE context sharing restrictions among NFs, SBI connection information, a trigger UE de-registration with a re-registration indication to a slice, a trigger RRC connection release and assign back-off timer, to terminate a malicious relay node and/or reselect a relay node, a network triggered AMF reallocation, a network triggered RAN reallocation, or a combination thereof.

In one embodiment, an apparatus comprises: a processor; and a memory coupled to the processor, the processor configured to cause the apparatus to: receive a first request message from a second NF, wherein the first request message comprises a trust service subscription request message corresponding to a trust service subscription; perform inference data collection; perform a trust evaluation service corresponding to the trust service subscription to produce trust evaluation data, wherein the trust evaluation service is performed based at least in part on the inference data collected; and transmit a first response message to the second NF, wherein the first response message comprises information corresponding to the trust evaluation data.

In certain embodiments, the apparatus comprises a TESF, security monitoring and evaluation function, network data analytics function, or a combination thereof.

In some embodiments, the second NF comprises a trust service consumer function.

In various embodiments, the first request message further comprises trust service consumer information, evaluation target information, or a combination thereof.

In one embodiment, the trust service consumer information comprises a NF ID, an NF type, an NF fingerprint, a container fingerprint, an NF software configuration, release information, or a combination thereof.

In certain embodiments, the first request message further comprises a list of trust service related service codes, configuration issue information, an attack alert, a threat alert, a malfunction alert, an overload alert, a flooding alert, a critical location alert, software issue information, a target of trust service reporting, evaluation target information, a notification of a target address, a subscription correlation identifier, a trust service target period, a reporting mode, a trust level specific cause code required indication, or a combination thereof.

In some embodiments, the evaluation target information comprises a UE ID, a NF ID having NF type information, an AF ID having AF information, or a combination thereof.

In various embodiments, the inference data comprises: data from evaluation targets, a malformed message, a signed NF information, a container image, a package, NF deployed location and platform information, a software configuration information change alert, a malicious activity alert, malicious behavior information, a trigger and/or alert related to an unintended configuration and/or an operational change, a message exceeding a configured limit per time instance, repeated authentication failure information, a network generated location mismatch, a UE generated location mismatch, RRC overflow information related to any UE ID, NAS overflow information related to any UE ID, malicious subscription data request overflow for any UE ID at a UDM, malicious traffic information for local UPFs from the UE, malicious signaling to the local UPFs from a RAN, or a combination thereof.

In one embodiment, the interference data is collected from evaluation targets using another NF or a management function.

In certain embodiments, the processor is configured to cause the apparatus to receive a second request message from the second NF, and the second request message comprises a trust evaluation request message corresponding to the trust service subscription.

In some embodiments, the processor is configured to cause the apparatus to receive a third request message from the second NF, and the third request message comprises a trust service unsubscription request message corresponding to the trust service subscription.

In various embodiments, the first response message further comprises trust information, a root cause code, a recommended action to ensure seamless network service, or a combination thereof.

In one embodiment, the trust information comprises values to represent a security state of an evaluation target NF, values to represent a reliability of the evaluation target NF, values to represent a trust worthiness of the evaluation target NF, or a combination thereof.

In certain embodiments, the root cause code comprises a code corresponding to: man-in-the middle attack, DOS attack, DDOS attack, an injection attack, a flooding attack on a SBI, a flooding attack on a SEPP, a NF hijack, a NF compromise, IP spoofing, a protocol or implementation flaw, an NF deployment location, a security threat, or a combination thereof.

In some embodiments, the recommended action comprises information indicating: network slice selection enforcement based on a trust value, a NSSAI configuration with a required trust value, security context sharing and/or usage policy enforcement information, a trigger for network slice reselection, an update to maintain a trust value per network slice within a time window, UE context sharing restrictions among NFs, SBI connection information, a trigger UE de-registration with a re-registration indication to a slice, a trigger RRC connection release and assign back-off timer, to terminate a malicious relay node and/or reselect a relay node, a network triggered AMF reallocation, a network triggered RAN reallocation, or a combination thereof.

In one embodiment, a method at a first NF, the method comprises: receiving a first request message from a second NF, wherein the first request message comprises a trust service subscription request message corresponding to a trust service subscription; performing inference data collection; performing a trust evaluation service corresponding to the trust service subscription to produce trust evaluation data, wherein the trust evaluation service is performed based at least in part on the inference data collected; and transmitting a first response message to the second NF, wherein the first response message comprises information corresponding to the trust evaluation data.

In certain embodiments, the first NF comprises a TESF, security monitoring and evaluation function, network data analytics function, or a combination thereof.

In some embodiments, the second NF comprises a trust service consumer function.

In various embodiments, the first request message further comprises trust service consumer information, evaluation target information, or a combination thereof.

In one embodiment, the trust service consumer information comprises a NF ID, an NF type, an NF fingerprint, a container fingerprint, an NF software configuration, release information, or a combination thereof.

In certain embodiments, the first request message further comprises a list of trust service related service codes, configuration issue information, an attack alert, a threat alert, a malfunction alert, an overload alert, a flooding alert, a critical location alert, software issue information, a target of trust service reporting, evaluation target information, a notification of a target address, a subscription correlation identifier, a trust service target period, a reporting mode, a trust level specific cause code required indication, or a combination thereof.

In some embodiments, the evaluation target information comprises a UE ID, a NF ID having NF type information, an AF ID having AF information, or a combination thereof.

In various embodiments, the inference data comprises: data from evaluation targets, a malformed message, a signed NF information, a container image, a package, NF deployed location and platform information, a software configuration information change alert, a malicious activity alert, malicious behavior information, a trigger and/or alert related to an unintended configuration and/or an operational change, a message exceeding a configured limit per time instance, repeated authentication failure information, a network generated location mismatch, a UE generated location mismatch, RRC overflow information related to any UE ID, NAS overflow information related to any UE ID, malicious subscription data request overflow for any UE ID at a UDM, malicious traffic information for local UPFs from the UE, malicious signaling to the local UPFs from a RAN, or a combination thereof.

In one embodiment, the interference data is collected from evaluation targets using another NF or a management function.

In certain embodiments, the method further comprises receiving a second request message from the second NF, wherein the second request message comprises a trust evaluation request message corresponding to the trust service subscription.

In some embodiments, the method further comprises receiving a third request message from the second NF, wherein the third request message comprises a trust service unsubscription request message corresponding to the trust service subscription.

In various embodiments, the first response message further comprises trust information, a root cause code, a recommended action to ensure seamless network service, or a combination thereof.

In one embodiment, the trust information comprises values to represent a security state of an evaluation target NF, values to represent a reliability of the evaluation target NF, values to represent a trust worthiness of the evaluation target NF, or a combination thereof.

In certain embodiments, the root cause code comprises a code corresponding to: man-in-the middle attack, DOS attack, DDOS attack, an injection attack, a flooding attack on a SBI, a flooding attack on a SEPP, a NF hijack, a NF compromise, IP spoofing, a protocol or implementation flaw, an NF deployment location, a security threat, or a combination thereof.

In some embodiments, the recommended action comprises information indicating: network slice selection enforcement based on a trust value, a NSSAI configuration with a required trust value, security context sharing and/or usage policy enforcement information, a trigger for network slice reselection, an update to maintain a trust value per network slice within a time window, UE context sharing restrictions among NFs, SBI connection information, a trigger UE de-registration with a re-registration indication to a slice, a trigger RRC connection release and assign back-off timer, to terminate a malicious relay node and/or reselect a relay node, a network triggered AMF reallocation, a network triggered RAN reallocation, or a combination thereof.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus for performing a first network function (NF), the apparatus comprising:
at least one memory; and
at least one processor coupled with the at least one memory and configured to cause the apparatus to:
receive a first request message from a second NF, wherein the first request message comprises a trust service subscription request message corresponding to a trust service subscription;
perform inference data collection;
perform a trust evaluation service corresponding to the trust service subscription to produce trust evaluation data, wherein the trust evaluation service is performed based at least in part on the inference data collected; and
transmit a first response message to the second NF, wherein the first response message comprises information corresponding to the trust evaluation data.

2. The apparatus of claim 1, wherein the apparatus comprises a trust evaluation and enabler service function and/or framework (TESF), security monitoring and evaluation function, network data analytics function, or a combination thereof, and wherein the second NF comprises a trust service consumer function.

3. The apparatus of claim 1, wherein the first request message further comprises trust service consumer information, evaluation target information, or a combination thereof.

4. The apparatus of claim 3, wherein the trust service consumer information comprises a NF identifier (ID), an NF type, an NF fingerprint, a container fingerprint, an NF software configuration, release information, or a combination thereof.

5. The apparatus of claim 3, wherein the first request message further comprises a list of trust service related service codes, configuration issue information, an attack alert, a threat alert, a malfunction alert, an overload alert, a flooding alert, a critical location alert, software issue information, a target of trust service reporting, evaluation target information, a notification of a target address, a subscription correlation identifier, a trust service target period, a reporting mode, a trust level specific cause code required indication, or a combination thereof.

6. The apparatus of claim 5, wherein the evaluation target information comprises a user equipment (UE) ID, a NF ID having NF type information, an application function (AF) ID having AF information, or a combination thereof.

7. The apparatus of claim 1, wherein the inference data comprises:
data from evaluation targets, a malformed message, a signed NF information, a container image, a package, NF deployed location and platform information, a software configuration information change alert, a malicious activity alert, malicious behavior information, a trigger and/or alert related to an unintended configuration and/or an operational change, a message exceeding a configured limit per time instance, repeated authentication failure information, a network generated location mismatch, a UE generated location mismatch, radio resource control (RRC) overflow information related to any UE ID, non-access stratum (NAS) overflow information related to any UE ID, malicious subscription data request overflow for any UE ID at a unified data management (UDM), malicious traffic information for local user plane functions (UPFs) from the UE, malicious signaling to the local UPFs from a radio access network (RAN), or a combination thereof.

8. The apparatus of claim 1, wherein the interference inference data is collected from evaluation targets using another NF or a management function.

9. The apparatus of claim 1, wherein the at least one processor is configured to cause the apparatus to receive a second request message from the second NF, and the second request message comprises a trust evaluation request message corresponding to the trust service subscription.

10. The apparatus of claim 1, wherein the at least one processor is configured to cause the apparatus to receive a third request message from the second NF, and the third request message comprises a trust service unsubscription request message corresponding to the trust service subscription.

11. The apparatus of claim 1, wherein the first response message further comprises trust information, a root cause code, a recommended action to ensure seamless network service, or a combination thereof.

12. The apparatus of claim 11, wherein the trust information comprises values to represent a security state of an evaluation target NF, values to represent a reliability of the evaluation target NF, values to represent a trust worthiness of the evaluation target NF, or a combination thereof.

13. The apparatus of claim 11, wherein the root cause code comprises a code corresponding to:
man-in-the middle attack, denial of service (DOS) attack, distributed DoS (DDoS) attack, an injection attack, a flooding attack on a service based interface (SBI), a flooding attack on a security edge protection proxy (SEPP), a NF hijack, a NF compromise, internet protocol (IP) spoofing, a protocol or implementation flaw, an NF deployment location, a security threat, or a combination thereof.

14. The apparatus of claim 11, wherein the recommended action comprises information indicating:
network slice selection enforcement based on a trust value, a network slice selection assistance information (NSSAI) configuration with a required trust value, security context sharing and/or usage policy enforcement information, a trigger for network slice reselection, an update to maintain a trust value per network slice within a time window, UE context sharing restrictions among NFs, service based interface (SBI) connection information, a trigger UE de-registration with a re-registration indication to a slice, a trigger radio resource control (RRC) connection release and assign back-off timer, to terminate a malicious relay node and/or reselect a relay node, a network triggered access and mobility management function (AMF) reallocation, a network triggered RAN reallocation, or a combination thereof.

15. A method of performing a first network function (NF), the method comprising:
receiving a first request message from a second NF, wherein the first request message comprises a trust service subscription request message corresponding to a trust service subscription;
performing inference data collection;
performing a trust evaluation service corresponding to the trust service subscription to produce trust evaluation data, wherein the trust evaluation service is performed based at least in part on the inference data collected; and
transmitting a first response message to the second NF, wherein the first response message comprises information corresponding to the trust evaluation data.

16. The method of claim 15, wherein the second NF comprises a trust service consumer function.

17. The method of claim 15, wherein the first request message further comprises trust service consumer information, evaluation target information, or a combination thereof.

18. The method of claim 17, wherein the trust service consumer information comprises a NF identifier (ID), an NF type, an NF fingerprint, a container fingerprint, an NF software configuration, release information, or a combination thereof.

19. The method of claim 17, wherein the first request message further comprises a list of trust service related service codes, configuration issue information, an attack alert, a threat alert, a malfunction alert, an overload alert, a flooding alert, a critical location alert, software issue information, a target of trust service reporting, evaluation target information, a notification of a target address, a subscription correlation identifier, a trust service target period, a reporting mode, a trust level specific cause code required indication, or a combination thereof.

20. The method of claim 19, wherein the evaluation target information comprises a user equipment (UE) ID, a NF ID having NF type information, an application function (AF) ID having AF information, or a combination thereof.
